(19) United States
(12) Patent Application Publication
(10) Pub. No.: US 2005/0254629 A1
(43) Pub. Date: Nov. 17, 2005

(54) Measurement noise reduction for signal quality evaluation

(76) Inventors: Zhu Xing China, Singapore (SG); Dennis Sh Goh, Singapore (SG); Hu Shenggang, Singapore (SG)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/846,309

(22) Filed: May 14, 2004

(51) Int. Cl. H04M 1/24; H04M 3/08

(52) U.S. Cl. 379/24; 379/1.01

(57) ABSTRACT

Disclosed are systems and methods for providing measurement noise reduction when making signal quality evaluation measurements. Embodiments operate to obtain a signal sample which includes measurement system induced noise as well as network system induced noise, obtain a noise profile of the measurement system induced noise, and optionally obtain information with respect to interfaces used in coupling the measurement system to the network system. The foregoing signal sample, noise profile and information, or some portion thereof, is used by embodiments to perform noise cancellation wherein measurement system induced noise is cancelled without substantially affecting network system induced noise, thereby providing an accurate signal sample for signal quality evaluation measurement.

### TECHNICAL FIELD

The invention relates generally to signal quality evaluation and, more particularly, to techniques for reducing noise introduced when making measurements for signal quality evaluation.

### BACKGROUND OF THE INVENTION

It is often desirable for a service provider, network operator, subscriber, or the like to obtain information with respect to the quality of a signal as carried through a network. For example, a service provider may guarantee a particular signal quality (e.g., maximum noise level) when that service provider's network is used for communication of signals. Likewise, industry standards, such as the International Telecommunication Union Telecommunication Standardization Sector (ITU-T) recommendations, may establish a minimum signal quality for particular network services, such as for a carrier of voice signals. Evaluating signal quality to ensure such a minimum signal quality is met may be particularly important when employing network connections and/or nodes that the service provider does not control, such as in the case of the Internet. For example, although voice over Internet protocol (VoIP) is becoming popular due to there being no tariff structure for long distance calls, as in the interlata calls placed over the public switched telephone network (PSTN), the Internet provides an eclectic set of nodes and links, various combinations of which may be used in any one communication session. Accordingly, it may be important to providers and/or users of such services to periodically evaluate the quality of signals carried through such means to ensure that they meet the stands of voice quality transmission.

Voice quality evaluation systems, often referred to as a voice quality tester (VQT), have been developed which objectively quantify voice quality on telelphony devices and circuits. For example, a VQT may qualify signals transmitted through a network with corresponding ITU-T recommendations on voice quality, such as set forth in ITU-T P.862: “PESQ—Perceptual Evaluation of Speech Quality,” and ITU-T P861: “PSQM—Perceptual Speech Quality Measure,” each of which is incorporated herein by reference. Examples of voice quality evaluation systems operable to quantify voice quality on telephony devices and circuits include the VQT Portable Analyzer, model J1981B, the VQT Network Server, model J1987B, the VQT Responder Unit, model J5426A, and the VQT Software Edition, model J5479A, each available from Agilent Technologies, Inc., Palo Alto, Calif.

In operation, voice quality evaluations are executed by coupling the VQT to a telephone network to be tested using the appropriate interfaces. An original test speech sample is fed to the telephone network under test through the measurement interface of the VQT (source side) and the degraded speech sample is obtained through the measurement interface of the VQT (destination side). A voice quality score (e.g., PESQ) is then derived from analysis of the original speech sample and the degraded speech sample. The calculation of the voice quality score of such VQTs are based on digitalized speech signals because most modern network infrastructure carries such signals digitally.

In order to facilitate connection of VQTs to various networks and/or in various situations, two general types of measurement interfaces are supported by such VQTs. Specifically, digital interfaces (e.g., E1, T1, 10/100, and the like) and analog interfaces (e.g., FXO, E&M, and the like) are supported by the foregoing VQTs. Although most modern network infrastructure may carry signals digitally, the “last mile” of a circuit is often analog. Similarly, voice signals are generally in an analog format when received from and provided to a calling party. Accordingly, it is often useful to provide an analog interface with respect to a VQT to convert analog speech signals to digital speech signals, and vice versa, and thereby facilitate interfacing a VQT to a network in a variety of situations, even though the calculation of the voice quality score of VQT may be based on the digitalized speech signals.

However, VQT analog interfaces will often introduce electrical noise (referred to herein as measurement noise) to the speech samples or other signals under evaluation during the signal conversion process. Thus, speech samples vitiated with measurement noise (which is introduced only in the measurement process and is not perceived by users of the network in normal operation) are used to calculate of the voice quality score. The obtained voice quality scores are, therefore, affected by extra noise (measurement noise) such that the expected pure scores that reflect the exact voice quality of the telephone network under test are not realized.

### BRIEF SUMMARY OF THE INVENTION

The present invention is directed to systems and methods which reduce noise introduced when making measurements for signal quality evaluation. Embodiments of the invention operate to reduce measurement noise associated with the use of noisy interfaces, such as analog interfaces, and thus improve the performance of a voice quality evaluation of a telecommunication network. Measurement noise reduction according to embodiments of the invention mitigates measurement noise without affecting noise introduced by the network under test to thereby provide an accurate and reliable signal quality evaluation.

Embodiments of the invention implement a plurality of functional modules in providing measurement noise reduction. For example, one embodiment implements a signal send/receive functional module, a measurement noise profile functional module, an interface information functional module, and a measurement noise reduction process functional module which cooperatively operate to provide measurement noise reduction according to the present invention. The foregoing signal send/receive functional module provides for communication and reception of test signals used in making quality evaluation measurements. The measurement noise profile functional module operates to provide a profile which represents the measurement noise introduced by interfaces of a measurement system. The interface information functional module provides information with respect to the particular interfaces utilized with respect to quality evaluation measurements. Information from each of the above functional modules are provided to the measurement noise reduction process functional module in the foregoing embodiment where one or more noise subtraction algorithms are implemented to reduce the measurement noise without substantially affecting noise introduced into a sampled signal by the network under test.

Embodiments of the present invention may be provided in centralized or decentralized configurations. For example, a centralized configuration may be implemented wherein all measurement noise is profiled and/or reduced by a same test apparatus (e.g., centralized VQT system). Alternatively, a decentralized configuration may be implemented wherein some aspect of measurement noise (e.g., source side interface or destination side interface) is profiled and/or reduced by different test system components (e.g., source side and destination side components of a decentralized VQT system).

### BRIEF DESCRIPTION OF THE DRAWING

For a more complete understanding of the present invention, reference is now made to the following descriptions taken in conjunction with the accompanying drawing, in which:

FIG. 1 shows a voice quality evaluation system adapted according to an embodiment of the present invention;

FIG. 2 shows detail with respect to an embodiment of the voice quality evaluation system of FIG. 1;

FIG. 3 shows a flow diagram of operation of a send/receive functional module of an embodiment of the present invention;

FIG. 4 shows a flow diagram of operation of a measurement noise profile functional module of an embodiment of the present invention;

FIG. 5 shows a flow diagram of operation of an interface information functional module of an embodiment of the present invention;

FIG. 6 shows a flow diagram of operation of a measurement noise reduction process functional module of an embodiment of the present invention; and

FIG. 7 shows a functional block diagram of a software implementation of an embodiment of the present invention.

### DETAILED DESCRIPTION OF THE INVENTION

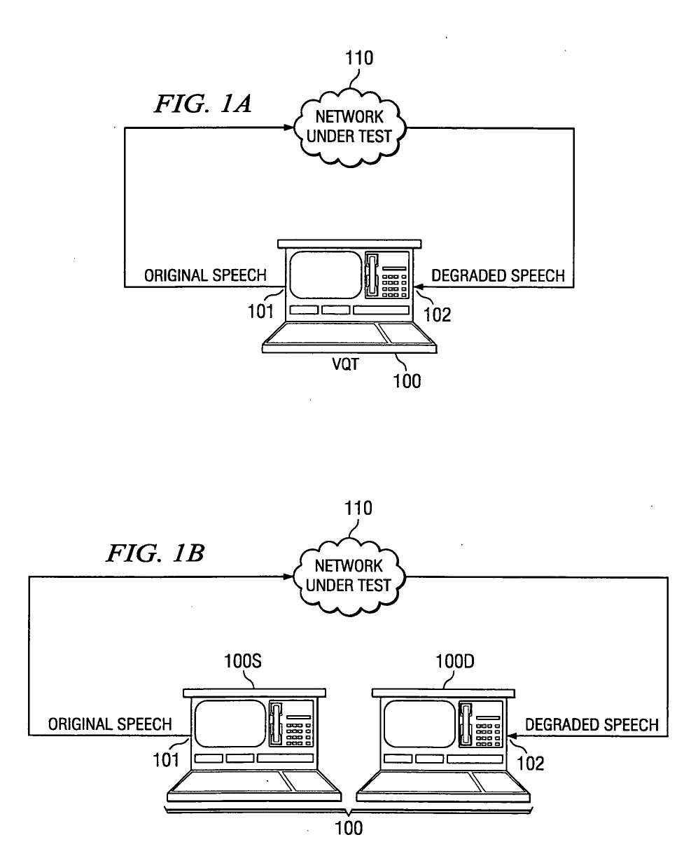

Directing attention to FIG. 1A, a voice quality evaluation system adapted according to embodiments of the present invention is shown. Specifically, FIG. 1A shows a centralized configuration of voice quality tester (VQT) 100 coupled to a network under test, shown as network 110, via source measurement interface 101 and destination measurement interface 102.

VQT 100 of embodiments of the invention comprises a processor-based system in which a processor is operable under control of an instruction set defining operation as described herein. The aforementioned processor-based system, in addition to source measurement interface 101 and destination measurement interface 102 shown, may include memory, such as random access memory (RAM), read only memory (ROM), magnetic and/or optical disk media, etcetera, input/output interfaces and devices, such as a keyboard, a digital pointer, a video display, a printer, a network interface card (NIC), a modem, a serial interface, etcetera, and/or other components useful according to embodiments of the invention. Embodiments of the present invention may be implemented as computer program code or other instruction sets operable upon the apparatus of prior VQT systems, such as the above mentioned VQT Portable Analyzer, VQT Network Server, and/or VQT Responder Unit available from Agilent Technologies, Inc., Palo Alto, Calif.

Although VQT 100 is illustrated as a single system, such as may provide a centralized configuration, embodiments of VQT 100 may comprise a plurality of systems cooperating to provide operation as described herein. For example, VQT 100 and functional modules thereof may be provided in a distributed or decentralized configuration as shown in FIG. 1B wherein remotely disposed systems 100S and 100D are in communication, perhaps through network 110 or another network, and cooperate to provide operation of VQT 100.

Network 110 may comprise any network or combination of networks. For example, network 110 may comprise the public switched telephone network (PSTN), the Internet, a local area network (LAN), a metropolitan area network (MAN), a wide area network (WAN), a cable transmission system, a satellite communication system, etcetera, and combinations thereof. Network 110 may transport signals using one or more protocols, including a variety of digital and analog protocols.

According to embodiments of the invention, source measurement interface 101 and destination measurement interface 102 accommodate a plurality of interface protocols to facilitate coupling VQT 100 to network 110 in a variety of different situations and/or to facilitate coupling VQT 100 to various networks (not shown). Source measurement interface 101 and destination measurement interface 102 of embodiments of the invention provide analog and digital interfaces. For example, source measurement interface 101 and destination measurement interface 102 may accommodate E1, T1, Ethernet 10/100, and/or other digital protocols as well as FXO, E&M, and/or other analog protocols. According to embodiments of the invention, source measurement interface 101 may implement an interface protocol different than that implemented by destination measurement interface 102 when coupled to network 110 for voice quality evaluation, where appropriate.

In operation to provide voice quality evaluation of network 110, VQT 100 feeds an original test speech sample to network 110 via source measurement interface 101 and obtains a degraded speech sample from network 110 via destination measurement interface 102. The degraded speech sample includes noise, signal distortion, etcetera introduced into the signal as a result of being carried by the components of network 110 (network noise). Moreover, the degraded speech sample may include noise, signal distortion, etcetera introduced into the signal by one or more components of VQT 100 (measurement noise). In order to provide an accurate analysis of voice quality as carried by network 110, VQT 100 adapted according to embodiments of the present invention operates to remove or otherwise mitigate the effects of measurement noise without substantially affecting network noise which may be present in a sample.

Although noise reduction techniques are known in the art, it should be appreciated that existing techniques operate to reduce or attempt to remove all noise present in a signal. Operation of the present invention presents a unique situation in which some noise (i.e., that introduced by the network) is to remain unaffected by implementation of a noise reduction technique whereas other noise (i.e., that introduced by the test system) is to be removed or otherwise mitigated as completely as is possible. Further complicating operation to reduce measurement noise is the possibility that different voice quality test scenarios, wherein different interfaces and/or combinations of interfaces, will be used.

Accordingly, during measurement noise reduction, VQT 100 of embodiments of the invention operates to reduce only the measurement noise and to avoid introducing distortion into the signal as much as possible. Additionally, VQT 100 provides measurement noise reduction operation which addresses situations in which different voice quality test scenarios with different combinations of measurement interfaces, such that the corresponding noise interfused in different places (e.g. source/destination) has different affects to the speech signal, are used.

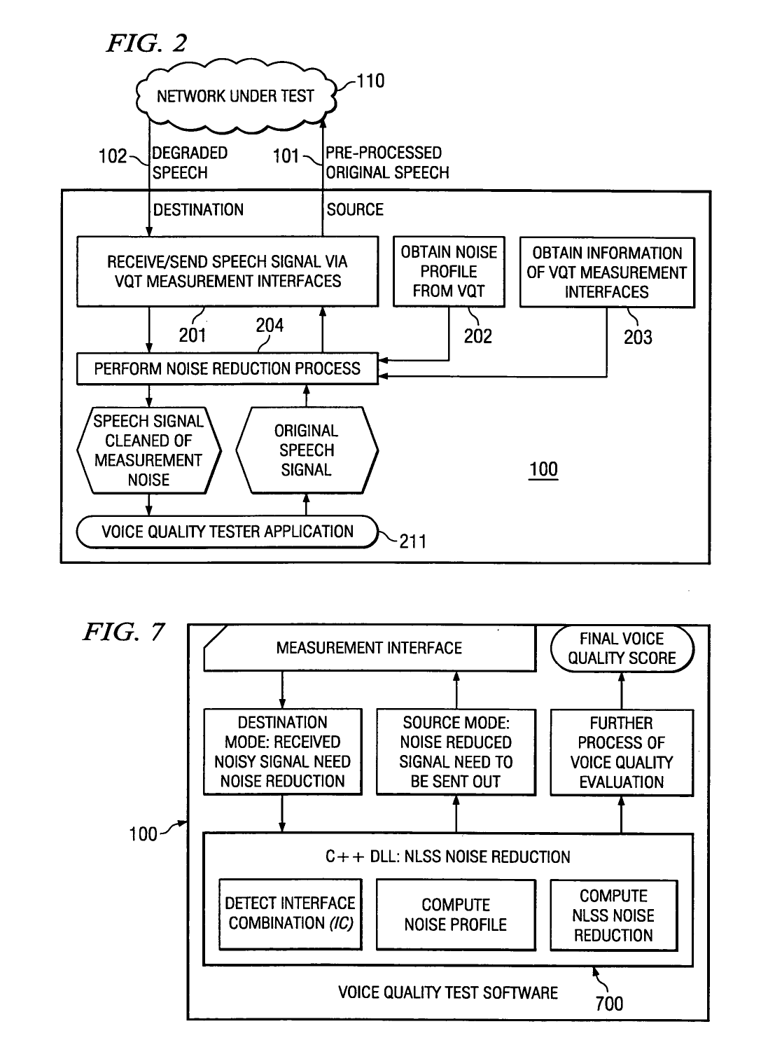

Directing attention to FIG. 2, further detail with respect to an embodiment of VQT 100 of FIG. 1 is shown. Specifically, a functional block diagram operable to provide operation according to embodiments of the present invention is shown with respect to VQT 100. The embodiment of VQT 100 illustrated in FIG. 2 comprises signal send/receive functional module 201, VQT noise profile functional module 202, interface information functional module 203, and measurement noise reduction process functional module 204 coupled to voice quality tester application 211. According to embodiments of the invention, voice quality tester application 211 operates in a substantially conventional manner (e.g., comprising the VQT Software Edition available from Agilent Technologies, Inc. discussed above), with functional modules 201-204 providing improved operation with respect to signal quality evaluation.

Signal send/receive functional module 201 of embodiments of the invention operates to obtain signal samples, e.g., noisy speech signals, via VQT 100 measurement interfaces. For example, VQT 100 may store an original speech signal or signals (e.g., different signals for use in testing different networks or aspects of networks) in a memory thereof for transmission to network 110 via source measurement interface 101. Additionally, VQT 100 may store a received speech signal or signals (e.g., corresponding to an original speech signal transmitted by VQT 100) in a memory thereof which has been received from network 110 via destination measurement interface 102.

As previously mentioned, the computation of a voice quality score (e.g., PESQ) may be based upon an analysis of the original speech signal provided to the network under test and the corresponding degraded speech signal received from the network under test. However, measurement noise may be introduced into a speech signal by VQT 100, such as by source measurement interface 101 and/or destination measurement interface 102. Accordingly, VQT 100 of embodiments of the invention may operate to reduce measurement noise associated with source side introduction of measurement noise and/or destination side introduction of measurement noise.

Signal send/receive functional module 201, when operating in a destination mode (receive), stores a received degraded speech signal, such as in an audio file, so that a noisy speech signal y(i) can be obtained and provided to measurement noise reduction process functional module 204 for noise reduction according to embodiments of the invention. Embodiments of signal send/receive functional module 201, when operating in a source mode (send), may operate to store an original speech signal, such as in an audio file, so that the original speech signal y^{l}(i) can be obtained and provided to measurement noise reduction process functional module 204 for noise reduction according to embodiments of the invention. Moreover, signal send/receive functional module 201, where operating in a source mode, may store a speech signal which has been processed by applying measurement noise reduction by measurement noise reduction process functional module 204. Accordingly, a processed original speech signal x(i), which has been “pre-processed” for measurement noise reduction, may be transmitted by VQT 100 to reduce or otherwise mitigate measurement noise, such as that introduced at the source side by VQT 100.

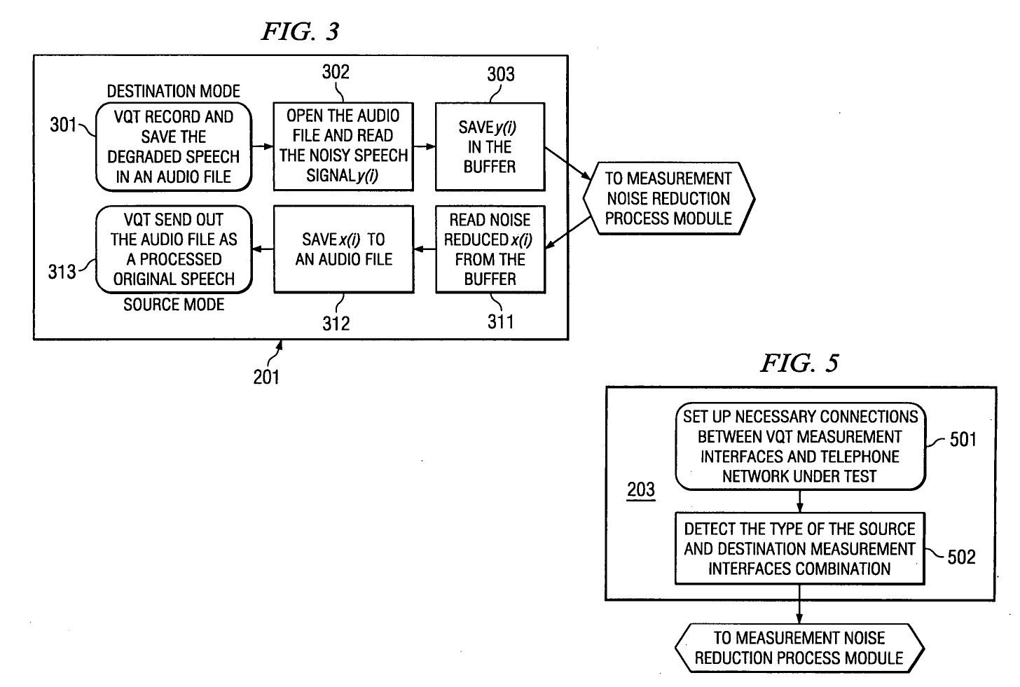

An embodiment of send/receive functional module 201 as set forth above is shown in FIG. 3, wherein flow diagrams of a destination mode and a source mode are shown. Specifically, in the destination mode illustrated in FIG. 3, at block 301 VQT 100 records and saves a degraded speech sample received from network 110 in an audio file. Thereafter, the audio file is read as a noisy speech signal y(i) for measurement noise reduction according to the present invention at block 302. According to the illustrated embodiment, the noisy speech signal y(i) is saved in a buffer for passing to measurement noise reduction process functional module 204. In the source mode illustrated in FIG. 3, at block 311 a processed original speech signal x(i) is read from a buffer for passing the signal from measurement noise reduction process functional module 204. Thereafter, the processed original speech signal x(i) is saved to an audio file for transmission to network 110 at block 312. According to the illustrated embodiment, the audio file is transmitted by VQT 100 to network 110 at block 313.

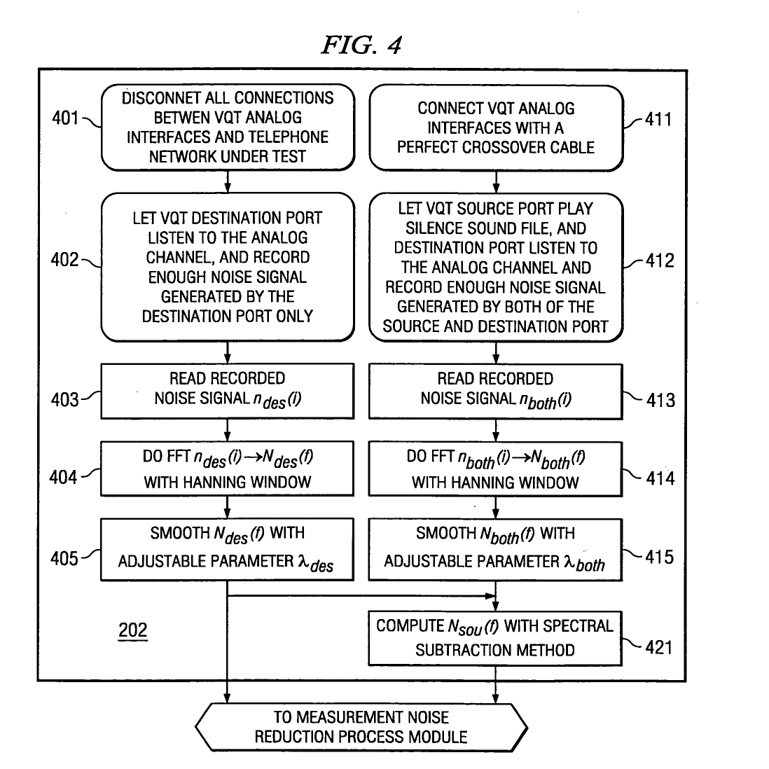

VQT noise profile functional module 202 of embodiments of the invention operates to profile measurement noise associated with the operation of VQT 100, or portions thereof. Detail with respect to obtaining a measurement noise profile according to embodiments of the invention is shown in the flow diagram of FIG. 4. The flow diagram of FIG. 4 includes 2 measurement noise profile obtaining stages. Specifically, blocks 401-405 are associated with obtaining a destination side measurement noise profile and blocks 411-415 are associated with obtaining a source and destination side measurement noise profile. Block 421 provides a feature in which a destination side measurement noise profile and a source and destination side measurement noise profile are used in obtaining a source side measurement noise profile.

Embodiments of the invention implement multiple stages for obtaining measurement noise profiles, such as a source side measurement noise profile and a destination side measurement noise profile. For example, an embodiment of VQT 100 may use a source side measurement noise profile to pre-reduce measurement noise associated with source measurement interface 101 and/or may use a destination side measurement noise profile to reduce measurement noise associated with destination measurement interface 102.

In operation according to the illustrated embodiment, obtaining the destination side measurement noise profile N_{des}(f) for a particular interface (e.g., one of analog interfaces FXO or E&M) of VQT 100 begins at block 401 wherein the particular destination interface of VQT 100 for which a measurement noise profile is disconnected from network 110 (as well as any other potential noise source). At block 402 VQT 100 “listens” to the particular destination interface of VQT 100 for which a measurement noise profile is being obtained and records a signal generated by this destination port only. Thereafter, the recorded noise signal n_{des}(i) may be read for computation of the destination side measurement noise profile at block 403. At block 404 the noise signal n_{des}(i) is used to compute the destination side measurement noise profile N_{des}(f). According to one embodiment, a fast Fourier transform (FFT), perhaps with a Hanning function to reduce aliasing, is used to compute the destination side measurement noise profile N_{des}(f). At block 405 the destination side measurement noise profile N_{des}(f) is smoothed, such as with a first order low-pass filter using an adjustable parameter λ_{des} (according to embodiments smoothing parameter λ_{des} is selected to be in the range of 0.5 to 0.99). Accordingly, after operation of the flow of blocks 401-405, VQT noise profile functional module 202 of embodiments of the invention provides a destination side measurement noise profile N_{des}(f) useful according to the present invention.

Obtaining the source and destination side measurement noise profile N_{both}(f) for a particular interface combination (e.g., one of analog interfaces FXO or E&M at the source and destination side) of VQT 100 begins at block 411 of the illustrated embodiment, wherein particular source and destination interface of VQT 100 for which a measurement noise profile is being obtained are connected using a crossover cable (also referred to as a “null” cable). At block 412 the particular source interface of VQT 100 for which a measurement noise profile is being obtained is controlled to “play” silence. Correspondingly, VQT 100 “listens” to the particular destination interface of VQT 100 for which a measurement noise profile is being obtained and records a signal generated, which includes noise generated by this destination port as well as the source port coupled thereto using the aforementioned crossover cable. Thereafter, the recorded noise signal n_{both}(i) may be read for computation of the source and destination side measurement noise profile at block 413. At block 414 the noise signal n_{both}(i) is used to compute the source and destination side measurement noise profile N_{both}(f). According to one embodiment, a FFT, perhaps with a Hanning function to reduce aliasing, is used to compute the source and destination side measurement noise profile N_{both}(f). At block 415 the source and destination side measurement noise profile N_{both}(f) is smoothed, such as with a first order low-pass filter using an adjustable parameter λ_{both} (according to embodiments smoothing parameter λ_{both} is selected to be in the range of 0.5 to 0.99). Accordingly, after operation of the flow of blocks 411-415, VQT noise profile functional module 202 of embodiments of the invention provides a source and destination side measurement noise profile N_{both}(f) useful according to the present invention.

Block 421 of the illustrated embodiment uses information obtained from each of the foregoing measurement noise profile stages to obtain an additional measurement noise profile. Specifically, block 421 of FIG. 4 computes a source side measurement noise profile using the source and destination side measurement noise profile determined by operation of blocks 411-415 and the destination side measurement noise profile determined by operation of blocks 401-405. According to one embodiment, source side measurement noise profile Nₛₒᵤ(f) is determined using a spectral subtraction method with respect to source and destination side measurement noise profile N_{both}(f) and destination side measurement noise profile N_{des}(f) (e.g., Nₛₒᵤ(f)=N_{both}(f)−N_{des}(f)), any or all of which may be provided to measurement noise reduction process functional module 204 for use in reducing measurement noise according to the present invention.

The measurement noise profiles of different types of interfaces (e.g. FXO or E&M) may be different. Accordingly, embodiments of the invention operate to perform the above steps with respect to each type of interface and each combination of interface types for which measurement noise is to be reduced in operation of VQT 100.

According to embodiments of the invention, noise profile acquisition of VQT noise profile functional module 202 is done before starting any analog interface related voice quality test by VQT 100. Studies of typical analog interfaces of VQT devices shows that the spectrum distribution of noise signals is relatively small between different time or different interface hardware. Based on this finding, embodiments of the invention obtain measurement noise profiles off-line, such as at a time of manufacture and/or during period calibration operations.

Interface information functional module 203 of embodiments of the invention operates to obtain information with respect to VQT measurement interfaces. In order to test voice quality of different routes with different signal types, modem voice quality tests performed by VQT 100 may include different voice quality test scenarios with different combinations of measurement interfaces. Typical interface combinations (IC) as may be utilized by VQT 100 in making voice quality measurements with respect to network 110 are listed in the table below. Embodiments of VQT 100 employ only analog interface related combinations with respect to interface information functional module 203 because digital interfaces (e.g., T1, E1, 10/100) typically do not introduce electrical noise when making the desired voice quality measurements.

| | VQT source side | VQT destination side |
|---|---|---|
| IC | measurement interface | measurement interface |
| 1 | FXO | FXO |
| 2 | E&M | E&M |
| 3 | FXO | E&M |
| 4 | E&M | FXO |
| 5 | FXO | 10/100 and T1/E1 |
| 6 | 10/100 and T1/E1 | FXO |
| 7 | E&M | 10/100 and T1/E1 |
| 8 | 10/100 and T1/E1 | E&M |

An embodiment of interface information functional module 203 as set forth above is shown in FIG. 5. At block 501 appropriate connections are provided between VQT 100 and network 110 in order to conduct voice signal testing. For example, any of digital interfaces operable according to T1, E1, or Ethernet 10/100 protocols or analog interfaces operable according to FXO or E&M protocols may be coupled to network 110 as a source side interface of VQT 100. Likewise, any of digital interfaces operable according to T1, E1, or Ethernet 10/100 protocols or analog interfaces operable according to FXO or E&M protocols may be coupled to network 110 as a destination side interface of VQT 100. At block 502 interface information functional module 203 operates to detect the type of source and destination measurement interfaces used and provides information with respect to the interface combination measurement noise reduction process functional module 204 for use in reducing measurement noise according to the present invention.

Measurement noise reduction process functional module 204 of embodiments of the invention operates to perform a measurement noise reduction process. Specifically, measurement noise reduction process functional module 204 of embodiments of the invention subtracts measurement noise from speech signals without affecting noise introduced by the network under test. Embodiments of measurement noise reduction process functional module 204 may implement nonlinear spectral subtraction (NLSS), wherein subtraction is performed with respect to frequency components of the signal. NLSS techniques are described in detail in Saeed V. Vaseghi, “Advanced Digital Signal Processing and Noise Reduction”, John Wiley & Sons Ltd., 2000, which is incorporated herein by reference.

However, existing NLSS algorithms cannot be straightforwardly applied in the measurement noise reduction of measurement noise reduction process functional module 204 because noise introduced by the network under test would be reduced, thereby affecting a resulting voice quality evaluation. For example, a typical procedure for noise reduction is to detect the no-speech part of a signal during speech, use the no-speech part to estimate noise profile, and reduce noise with the profile. In such a process all the background noise, whether measurement noise or network noise, is reduced. Embodiments of the present invention, however, reduce only the measurement noise (e.g., noise introduced by the source and destination analog interfaces of the VQT), while keeping all other kinds of noise (e.g., noise introduced by the network under test) which is relevant to the signal quality evaluation.

According to embodiments of the invention, the measurement noise introduced in different points (e.g., source/destination) of the voice quality system are reduced with different processes, such as may utilize the foregoing source measurement noise profile and destination measurement profile. For example, a first NLSS process may be utilized with respect to a source measurement noise profile to reduce source side measurement noise and a second NLSS process may be utilized with respect to a destination measurement noise profile to reduce destination side measurement noise. Such separate measurement noise processes may be advantageous in that source side measurement noise may be “pre-processed” with respect to a source signal before being introduced into a network under test. Of course, there is no limitation with respect to embodiments of the present invention utilizing the same or different measurement noise reducing processes with respect to measurement noise introduced in different points of the voice quality system.

The measurement noise introduced by different interfaces and combinations of interfaces of the voice quality system are reduced with different processes according to embodiments of the invention. For example, the measurement noise introduced by different combinations of the analog FXO and E&M interfaces used as VQT 100 source interfaces and destination interfaces is reduced using different NLSS processes, as may be utilized with respect to source measurement noise profiles, destination measurement noise profiles, and source and destination measurement noise profiles corresponding to the particular interfaces and combinations of interfaces employed.

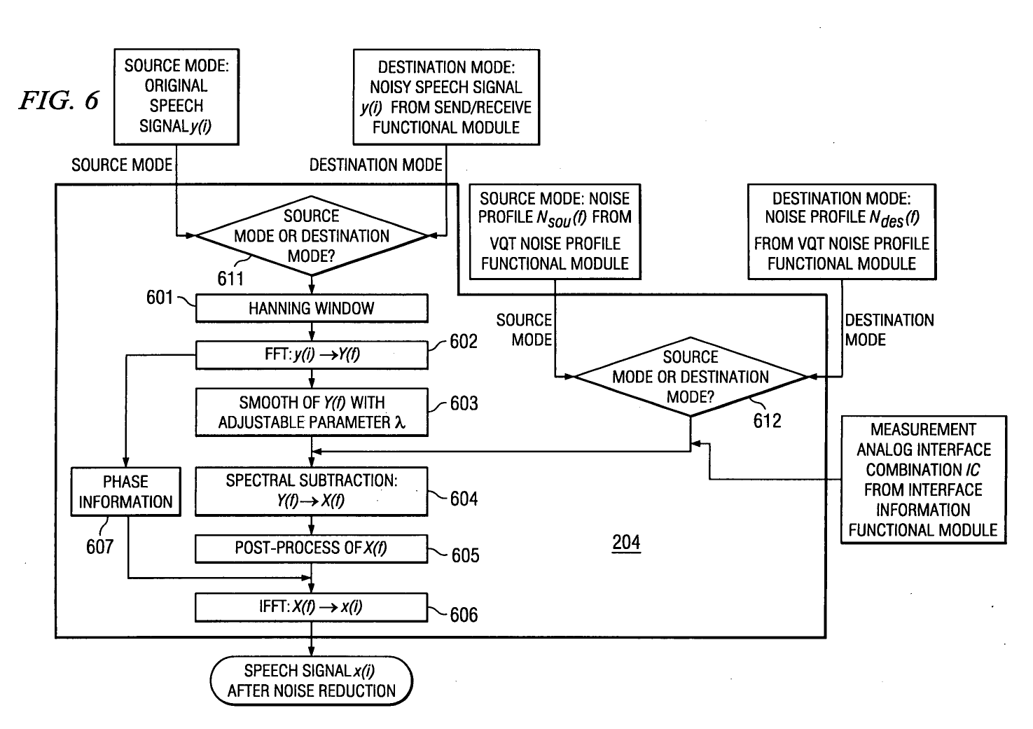

Directing attention to FIG. 6, a flow diagram showing operation of measurement noise reduction process functional module 204 implementing a NLSS noise reduction process according to one embodiment is shown. Decision block 611 performs a determination as to whether measurement noise reduction process functional module 204 is operating in a source mode (e.g., to pre-reduce source side measurement noise) or a destination mode (e.g., to reduce destination side measurement noise), and selects appropriate input for operation of measurement noise reduction process functional module 204 in the determined mode. At block 601 measurement noise reduction process functional module 204 accepts an original speech signal (source mode) as y(i) or a noisy speech signal (destination mode) as y(i) and performs a Hanning function with respect thereto to reduce aliasing. Block 602 performs a FFT with respect to the accepted speech signal y(i) to compute the spectrum Y(f) of the original speech signal (clean signal sample or clean speech signal) or the noisy speech signal (noisy signal sample which includes both measurement noise and network noise). The speech signal spectrum Y(f) computed in block 602 is provided to block 607 wherein phase information derived in block 602 is saved in a buffer for subsequent use by measurement noise reduction process functional module 204. At block 603 the speech signal spectrum Y(f) is smoothed, such as with a first order low-pass filter using an adjustable parameter λ (according to embodiments smoothing parameter X is selected to be in the range of 0.1 to 0.5).

Block 604 of the illustrated embodiment of measurement noise reduction process functional module 204 performs spectral subtraction of the speech signal spectrum Y(f) provided by block 603 and noise profile N(f) which includes only measurement noise to provide processed speech signal X(f), which in the source mode is pre-processed for source side measurement noise and in the destination mode includes only network noise. Accordingly, the illustrated embodiment of block 604 receives noise profile information appropriate to the particular mode of operation (e.g., Nₛₒᵤ(f) for source mode or N_{des}(f) for destination mode) from VQT noise profile functional module 202 via decision block 612. To facilitate the use of appropriate noise profiles, and thus appropriate measurement noise reduction processes, for the particular interface combination being used by VQT 100 in testing network 110, block 604 of the illustrated embodiment also receives measurement interface combination information from interface information functional module 203.

According to embodiments of the invention, the noise profiles N(f) received at block 604 may include any of source side noise profile Nₛₒᵤ(f) and/or destination side noise profile N_{des}(f). For example, a distributed configuration of VQT 100 may receive source side noise profile Nₛₒᵤ(f) when operating in a source mode and destination side noise profile N_{des}(f) when operating in destination mode at block 604 as shown in FIG. 6. Accordingly, the spectral subtraction performed by block 604 may comprise Y(f)−Nₛₒᵤ(f) to provide a pre-processed original speech signal Xₛₒᵤ(f) which has been measurement noise associated with the source port pre-reduced and/or Y(f)−N_{des}(f) to provide a noise reduced noisy speech signal X_{des}(f) including only network noise.

An algorithm implemented in providing spectral subtraction in block 604 according to one embodiment of the invention is set forth below.
X(f)=Φ(Y(f),Nₛₒᵤ(f),N_{des}(f),α,IC) (1)
where X(f) is a processed speech signal spectrum derived from the variables Φ, Y(f), Nₛₒᵤ(f), N_{des}(f), α, and IC. The variable Φ represents the proper mapping function of the spectral subtraction. The variable Y(f) is the spectral magnitude of a speech signal upon which spectral subtraction is to be performed. The variables Nₛₒᵤ(f) and N_{des}(f) are the noise profiles. The variable a is an adjustable reduction factor used in optimizing the function. For example, for full noise subtraction α=1 and for over subtraction α>1 (when variance of noise profile for different cases is large). Embodiments of the invention utilize α in the range of 1 to 1.5. The variable IC provides information with respect to the source/destination interface combination implemented with respect to VQT 100. Further, α is used to determine the spectral subtraction factor, and IC is used to apply spectral subtraction of measurement noise interfused with different interface combinations.

Block 605 of the illustrated embodiment of measurement noise reduction process functional module 204 performs a post-process with respect to the computed processed speech signal spectrum X(f) in order to avoid negative magnitude estimation of the spectral subtraction output. A post-process as applied according to one embodiment of the present invention is shown below.

$$X ( f ) = \{ \begin{matrix}X ( f ) & if X ( f ) > β Y ( f ) \\ β Y ( f ) & otherwise\end{matrix} \qquad ( 2 )$$

where β is a tuning parameter which is related to the signal to noise ratio (SNR). A typical value for β according to embodiments of the invention is 0.01.

At block 606 a signal having reduced measurement noise is computed from the processed speech signal spectrum derived above. For example, an inverse FFT (IFFT) may be used with respect to the processed speech signal spectrum X(f) to provide a speech signal x(i) which, in source mode operation, has source side measurement noise pre-reduced and, in destination mode operation, has destination side measurement noise reduced, although containing network noise. This speech signal x(i) may be provided by measurement noise reduction process functional module 204 for transmission through the network under test as a pre-processed original speech signal in the source mode. Speech signal x(i) may be provided by measurement noise reduction process functional module 204 in destination mode to conventional aspects of VQT 100 for calculation of a voice quality score (e.g., PESQ), which is very accurate and reliable due to the measurement noise having been reduced in the sample.

From the above, it should be appreciated that a clean speech signal x(i) may be obtained according to embodiments of the present invention according to formula below.
x(i)=ψ(y(i),nₛₒᵤ(i),n_{des}(i),α,β,λ,IC) (3)
where ψ represents the proper NLSS algorithm which maps the input variables noisy speech signal y(i), measurement noise n(i), interface combination IC, and adjustable NLSS parameters α, β, λ.

Embodiments of the present invention implement the foregoing functional modules in software operable upon a processor-based VQT hardware platform, such as those of Agilent Technologies, Inc., of Palo Alto, Calif. discussed above. For example, embodiments of the invention have been implemented in software with Visual C++, wherein the C++DLL has been integrated into existing VQT software to provide operation as described herein. A functional block diagram of a Visual C++ embodiment of the invention is shown in FIG. 7. In the embodiment of FIG. 7, C++DLL module 700, providing operation according to send/receive functional module 201, VQT noise profile functional module 202, interface information functional module 203, and measurement noise reduction process functional module 204, is interfaced with other functional modules of VQT 100 to provide operation as set forth above.

Embodiments of the present invention implementing NLSS measurement noise reduction as set for the above have been tested with respect to VQT systems of Agilent Technologies, Inc. Typical results of such testing are shown in the table below. It can readily be appreciated from the data in the table that the voice quality score (PESQ-LQ) is improved after measurement noise reduction of the present invention.

VQT Analog Interface: FXO to FXO

Audio reference file: AGAM1F01.wav

| Network | | PESQ-LQ Score |
|---|---|---|
| Signal Loss | Original PESQ-LQ | after Measurement |
| (dB) | Score | Noise Reduction |
| 0 | 4.16 | 4.35 |
| 12 | 3.61 | 4.23 |

Although embodiments of the present invention have been discussed with respect to the transmission of voice or speech signals through telephone networks, the concepts of the present invention are applicable to any type of signal content transmitted over any form of network. Likewise, although measurement noise reduced according to embodiments of the present invention has bee described with reference to noise introduced by measurement interfaces, measurement noise reduced according to embodiments of the invention may be created by any number of devices, systems, or apparatus utilized with respect to testing and test equipment. Furthermore, although embodiments have been described herein which provide for the above processing to occur within a voice quality test system, or components thereof, embodiments of the invention may provide for processing as described above in any number of systems.

1. A method for reducing noise for signal quality evaluation, said method comprising:
determining a measurement noise profile for noise associated with the use of measurement equipment used in said signal quality evaluation; and
reducing, using said measurement noise profile, measurement noise from a signal sample without reducing other noise present in said signal sample.

2. The method of claim 1, wherein said signal sample is received from a network for which signal quality evaluation is to be performed, and wherein said other noise present in said signal sample comprises network noise introduced by transmission of said signal sample through said network.

3. The method of claim 2, further comprising:
transmitting a clean signal sample through said network using a source port of said measurement equipment; and
receiving a noisy signal sample from said network using a destination port of said measurement equipment, wherein said signal sample from which said measurement noise is reduced is said noisy signal sample.

4. The method of claim 2, further comprising:
transmitting a signal which has been pre-processed for measurement noise removal through said network using a source port of said measurement equipment, wherein said signal sample from which said measurement noise is reduced is said signal.

5. The method of claim 4, wherein said signal is pre-processed to reduce measurement equipment source port measurement noise.

6. The method of claim 4, further comprising:
receiving a noisy signal sample from said network using a destination port of said measurement equipment;
reducing measurement equipment destination port measurement noise from said noisy signal sample without reducing other noise present in said signal sample.

7. The method of claim 1, wherein said determining a measurement noise profile comprises:
determining a measurement noise profile associated with a destination port of said measurement equipment.

8. The method of claim 1, wherein said determining a measurement noise profile comprises:
determining a measurement noise profile associated with a source port and a destination port of said measurement equipment.

9. The method of claim 1, wherein said determining a measurement noise profile comprises:
determining a measurement noise profile associated with a source port of said measurement equipment.

10. The method of claim 9, wherein said determining said source port measurement noise profile comprises:
determining a measurement noise profile associated with a destination port of said measurement equipment;
determining a measurement noise profile associated with a source port and a destination port of said measurement equipment; and
performing spectral subtraction of said destination port noise profile from said source port and destination port noise profile.

11. The method of claim 1, further comprising:
determining a combination of measurement equipment source port and destination port used with respect to said signal sample, wherein said reducing said measurement noise uses information with respect to said combination of measurement equipment source port and destination port in applying said measurement noise profile for reducing said measurement noise from said signal sample.

12. A system for reducing noise for signal quality evaluation, said system comprising:
a destination port for coupling to a network for which signal quality evaluation is to be made;
a measurement noise profile functional module accepting a signal having measurement noise therein and calculating a measurement noise profile as a function of said measurement noise; and
a measurement noise reduction process functional module in communication with said measurement noise profile functional module and accepting said measurement noise profile therefrom, said measurement noise reduction process functional module using said measurement noise profile to reduce measurement noise from a signal received from said network by said destination port without reducing network noise in said signal introduced by said network.

13. The system of claim 12, further comprising:
a source port for coupling to a network for which signal quality evaluation is to be made, wherein said signal received from said network by said destination port is initially transmitted to said network via said source port.

14. The system of claim 13, wherein said measurement noise reduced by said measurement noise reduction process functional module comprises measurement noise introduced by ones of said source port and said destination port which implement analog communications.

15. The system of claim 13, wherein said measurement noise reduction process functional module reduces measurement noise introduced by said source port separately from reducing measurement noise introduced by said destination port.

16. The system of claim 15, wherein said measurement noise reduction process functional module is provided in a distributed configuration.

17. The system of claim 15, wherein said measurement noise reduction process functional module pre-processes said signal as initially transmitted by said source port to reduce measurement noise introduced by said source port.

18. The system of claim 13, further comprising:
an interface information functional module in communication with said measurement noise reduction process functional module and providing information with respect to a configuration of said source port used to initially transmit said signal to said network and said destination port used to receive said signal from said network.

19. A method for increasing accuracy in voice quality evaluation of a network when at least one analog voice quality tester is used in making network measurements, said method comprising:
determining a combination of voice quality tester source port and destination port configurations used in making network measurements;
calculating a measurement noise profile associated with the use of each of said source port and said destination port which provides analog communication configuration;
obtaining a voice signal sample from said network using said source port and said destination port; and
processing said voice signal sample to reduce measurement noise introduced into said voice signal sample by at least one of said source port and said destination port using said measurement noise profile without reducing network noise introduced by said network.

20. The method of claim 19, wherein a configuration of said source port and said destination port determined is selected from the group consisting of digital interfaces and analog interfaces, wherein said combination of said source port and said destination port configurations is selected from the group consisting of a digital interface source port configuration and an analog interface destination port configuration, an analog interface source port configuration and an analog interface destination port configuration, and an analog interface source port configuration and a digital interface destination port configuration.

21. The method of claim 20, wherein said analog interface is selected from the group consisting of FXO and E&M analog interfaces.

22. The method of claim 19, wherein said calculating a measurement noise profile comprises:
calculating a destination port noise profile for measurement noise associated with said destination port.

23. The method of claim 22, wherein said calculating a measurement noise profile comprises:
calculating a source and destination port noise profile for measurement noise associated with said source port and said destination port.

24. The method of claim 23, wherein said calculating a measurement noise profile comprises:
calculating a source port noise profile for measurement noise associated with said source port.

25. The method of claim 19, wherein said processing said voice signal sample to reduce measurement noise comprises:
employing nonlinear spectral subtraction using said measurement noise profile.
